(19) United States
(12) Patent Application Publication
(10) Pub. No.: US 2008/0033596 A1
(43) Pub. Date: Feb. 7, 2008

(54) Vision Feedback Detection for Vending Machines and the Like

(76) Inventors: Andrew T. Fausak, Coppell, TX (US); Lawrenne J. Quinnell, Discovery Bay, CA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/774,486

(22) Filed: Jul. 6, 2007

Related U.S. Application Data
(60) Provisional application No. 60/818,992, filed on Jul. 6, 2006.

(51) Int. Cl. G06F 19/00

(52) U.S. Cl. 700/244

(57) ABSTRACT

A dispensing machine includes a visual detection system, having one or more cameras with a field of view sufficient to see a region through which a properly dispensed product is expected to travel, captures at least one image frame during the time in which the product is expected to be within the field of view. The detection system visually detects the presence of items in a dispense or vending area, determining the type of product from one or more predetermined attributes. If the correct product has not been dispensed, an exception indication is generated. In the case of a vending machine, the exception may result in a refund or credit of any amounts actually paid.

This application claims the benefit of U.S. provisional application No. 60/818,992, filed Jul. 6, 2006, which is incorporated herein by reference for all purposes.

### BACKGROUND

Vending machines are found in many commercial establishments and other facilities such as schools, hospitals, and sports stadiums, and are used to dispense a wide variety of products such as drinks, stamps, toys, personal care products and a wide range of other items. Vending machines may accept payment in a variety of forms, including coins, paper money, credit cards, debit cards, smart cards, or remote authorization through, for example, mobile communication devices carried by the person requesting the item. Because the machines are unattended, the items available for vending must be kept in a relatively secure manner to discourage theft or unauthorized dispensing, but otherwise permit a person to take a dispensed item. In a typical vending machine, the items are stored in an array of racks or other storage structures, one for each type of item to be dispensed. The racks are located above a vend area that is structured for allowing access to the dispensed item but preventing a person from reaching the stored items. Actuation of a dispense mechanism for a rack, pushes out a predetermined number of items. Dispensed items eventually fall into an accessible dispense area nearer the bottom of the machine. Vending machines may also be adapted for selling or dispensing consigned items.

One problem that such machines face is the possibility of a failed transaction, in which the machine attempts to dispense the item but the item fails to fall into a dispense area accessible to the person requesting the item. In such a situation, the machine may assume that the item was dispensed and refuse to refund any money paid or otherwise count the item as having been dispensed.

### SUMMARY OF THE INVENTION

The invention concerns generally detection of objects dispensed by a dispensing machine, such as a vending machine, in order to determine whether a requested object has been successfully dispensed.

In one example of a dispensing machine embodying at least certain features of the invention in their preferred forms, a visual detection system, having one or more cameras with a field of view sufficient to see a region through which a properly dispensed product is expected to travel, captures at least one image frame during the time in which the product is expected to be within the field of view. If a product has not been dispensed, an exception indication is generated. In the case of a vending machine, the exception may result in a refund or credit of any amounts actually paid.

In one preferred, exemplary embodiment of such a machine, the visual detection system attempts to identify which product appears within the one or more images. Comparison is based on one or more predetermined attributes of the product. The attributes may include one or more of the following: the shape of the product, the size of the product, the color of the product, text or other graphical elements on the product, a UPC bar code on the product, and the like. The visual detection system indicates whether the product detected matches the product to have been dispensed, such as when a wrong product has been dispensed and/or a product has been dispensed when it should not have been. Preferably, the image, which will be a bitmapped image when captured by a camera, is converted to a vector graphic form for comparison to stored product templates.

These and other exemplary embodiments are described below in reference to the appended drawings.

### BRIEF DESCRIPTION OF DRAWINGS

FIG. 1 is a schematic representation of a representative vending machine utilizing a visual detection system for determining whether a selected item is properly dispensed to a designated area.

FIG. 2 is a flow diagram of a visual detection process for a vending machine.

FIG. 3 is a flow diagram of a visual detection process for a vending machine.

### DETAILED DESCRIPTION OF PREFERRED EMBODIMENTS

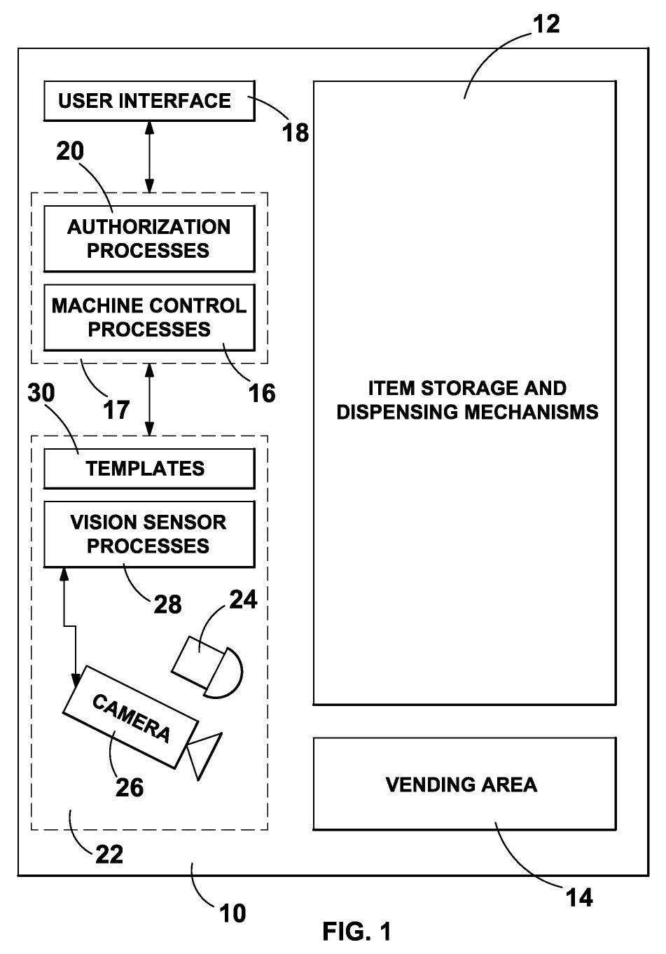

Referring to FIG. 1, exemplary embodiments of the invention will be described in reference to representative vending machine 10. Generally, a vending machine includes structures for storing products, and dispensing one or more stored items in response to a request if predefined conditions are met. FIG. 1 schematically illustrates logical representations of examples of these structures. Vending machine 10 includes storage structures 12 such as racks or carousels. Typically, each rack or carousel stores multiple numbers of a single type of item. Actuation of a dispensing mechanism associated with the rack or carousel structure causes an item to be dispensed, typically by moving it out of the rack or carousel so that it transported, typically but not always under the force of gravity, to a vending area 14, from which a person may retrieve the dispensed product. Vending area 14 is constructed in a manner that permits access by a person to a dispense product but discourages unauthorized access to products stored in the products racks. One example of a conventional storage and dispensing mechanism is a screw turned by a motor.

The vending machine performs certain processes in connection with vending items. The processes are carried out under the control of logic circuitry and/or one or more programmed processors, which as a group are logically indicated by a dashed lines 17. No particular arrangement of circuitry or processors is intended or implied by the dashed lines. The processors and/or logic circuitry may take the form of single computing device or multiple different processors and/or logic circuits. Different processes may execute on different computing components. A process may also be distributed across different computing components.

Dispense operations are controlled by processes which are collectively represented as an instance of machine control processes 16. A user interacts with the vending machine through a user interface 18. Communication between a user and the user interface typically includes user input specifying the item to be vended, canceling the transaction or requesting a refund. It may also include messages from the vending machine to the user.

The vending machine performs authorization processes in connection with dispensing requested items. These processes are represented collectively in FIG. 1 by authorization processes instance 20, which executes on programmable microprocessors and/or other types logic circuitry 17. The authorization processes may in whole or in part be integrated with machine control processes 16. The authorization process determines whether one or more conditions for authorizing a requested dispense has been met. These conditions may include, for example, payment of money, identification of the requesting party, and/or authorization from a remote authority. Thus, the authorization processes may interact with additional mechanisms, not shown, that could include, for example, a payment mechanism that accepts coins, bills and other forms of payment. Such mechanisms may in the alternative or in addition include a mechanism for identifying the requesting person, such as by biometric identification or through use of a token, such as card or other object presented by the person, and/or a mechanism for communicating with a remote authorization authority. These mechanisms may be part of or integrated into user interface 18. The authorization processes will communicate with the machine control processes to provide, for example, an indication that a condition has been satisfied.

In order to validate a vending transaction or, in other words, to determine whether an item has been properly dispensed into the vending area 14 or other designated area, vending machine 10 utilizes vision sensor system 22. In a preferred embodiment the vision sensor system 22 generates messages for machine control processes 16 indicating whether an item is detected in the vending area 14. It may additionally identify the item. In a preferred, exemplary embodiment the visual detection system is comprised of at least one camera 26 and software executing on a processor-based computing device for performing certain vision sensor processes. These processes could be instantiated and executing on the same processor as machine control processes 16. The system optimally also includes a light source 24 to illuminate the vending area. Ambient light and/or another source of illumination may be relied upon instead of, or in addition to, light source 24. These processes include in a preferred embodiment processes for visually detecting the presence of and attempting to identify a dispensed item in the vend area. An instance of these processes are schematically represented in FIG. 1 as vision sensor processes 28. Camera 26 preferably includes a 2-dimentional image sensor that generates digital still and/or video images of the vending area 14. The camera also includes optics. The optics may be integrated with the visual image sensor into a single, physical unit or may be separately mounted components. Multiple cameras may be deployed for views of the vending area 14 from different angles or of different portions of the vending area. Information describing the items stored by the vending machine is stored in one or more files or databases 30. This information will be referred to as item or product templates. It includes descriptions of visual features or characteristics of the products used by recognition processes to identify the products.

When an item is dispensed, the vision sensor captures one or more images at expiration of a predetermined period of time from a predetermined trigger point associated with the dispensing, such as the time the machine control processes 16 cause or initiate dispense of a product. Using these images, the vision sensor system detects the presence of an item and/or attempts to recognize or identify it. Should no product be detected, the vision system so indicates. The vision sensor system directly indicates that no item has been detected with a message once it has finished processing the images, or indirectly by, for example, not generating a message indicating detection. In the later instance, machine control processes assume that, in the absence of receiving within a predetermined period of time a message representing a positive detection, no item has been detected, or the correct item has not been detected. If an item is not detected, machine control process causes another item of the same type or another item of similar type to be dispensed, or causes payment to refunded or credit to be given. It may also send a message or notice to remote location. In the event that multiple items are detected, the vision sensor system can be programmed to detect this occurrence and indicate it to the machine controller processes, which then can cause the vending machine to request that the customer place the extra item in a return bin.

Vision sensor processes 28 may optionally execute on the same processors as machine control processes and/or authorization processes 20. The processes may also be integrated with the machine control processes. The machine controller, user interface, and visual dispense validation system, and/or authorization mechanism may optionally be integrated into a single system. An example of such a system would be a processor-based computer system connected to a display, a user input device, a payment collection device, and interfaces for controlling or actuating mechanical components of the product storage and dispensing mechanisms.

Alternatively, the vision sensor system 22 may be installed in the vending machine 10 as a separate system. In this alternative, the vision sensor system is communicatively coupled with one or more controllers on which machine controller processes 16 execute. For example, an interface is employed between the vision sensor system 22 and a controller on machine control processes 16 is running. The interface allows the vision sensor to receive information on the identity of the requested item from the controller, and for the vision sensor system to indicate whether or not the vend was valid according to pre-selected criteria. In one example of an interface, the controller sends a trigger signal to a relay or similar device after a predetermined period of time has elapsed from the vend. If the correct item is detected by the vision sensor system the relay will trigger in one state; conversely, if there is either no product present or optionally, a wrong product present, then the vision system will cause a different relay state to exist when triggered. The state is read by the controller.

In another example of a machine employing one or more features of the invention, the vision sensor system 22 can also be installed in a consignment cabinet, from which items are made available to in response to receiving authorization to dispense one or more selected items.

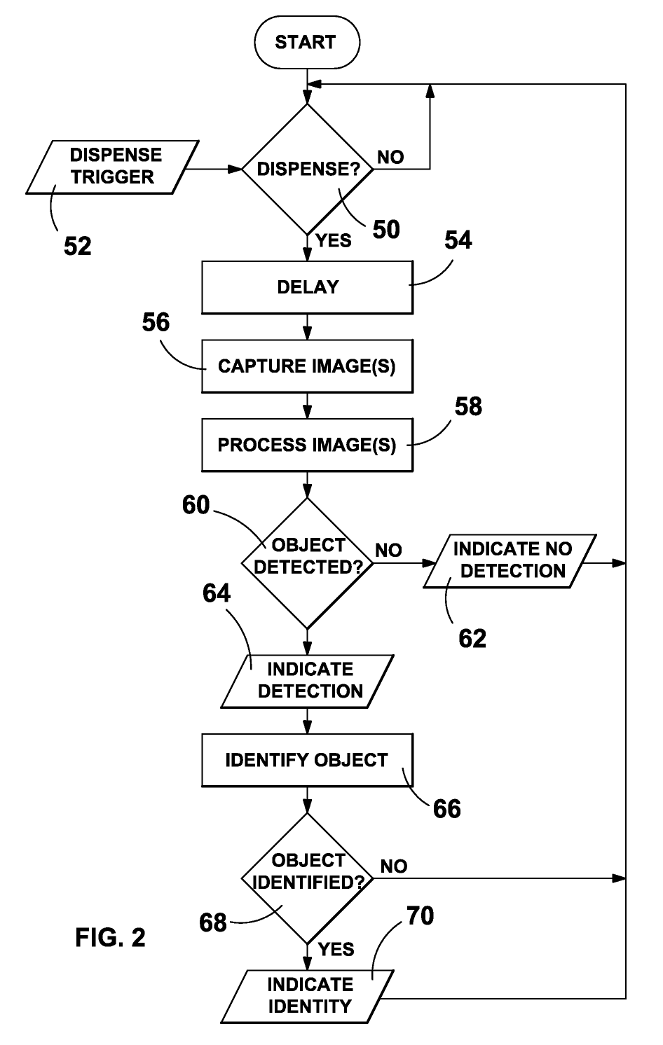

The flow diagram of FIG. 2 illustrated a representative process of vision sensor system 22. Referring to FIGS. 1 and 2, the process waits for a dispense to occur, as represented by decision step 50. In the illustrated embodiment, the vision sensor system receives a dispense trigger or indication 52 from the vending machine's controller. After a predetermined delay, which is represented by step 54, at least one camera 26 captures one or more images at step 56 and processes those images at step 58. If no object is detected in the images at step 60, the vision sensor system indicates at step 62 that no object has been detected and returns to step 50. Otherwise, it indicates at step 64 that an object has been detected. An indication may be given by communication of a signal or message representing a positive detection or by inference through no communication of a signal. The presence of an object is detected by, for example, comparing a captured image against a baseline image of the same field of view in which no dispensed item appears. The process may, optionally, stop at this step and return to step 50 if object recognition is not desired. However, it is preferable to attempt to identify or recognize the object, if possible. At step 66, the process attempts to identify the object that is detected. As represented by steps 68 and 70, an indication that the object has been identified, or an indication of the actual identity of the object, is provided if the object recognized before the process returns to step 50. Optionally, an indication of no identification can be provided. Furthermore, the indication of detection that was given at step 64 could instead, if desired, be given at the same time the object's identity is given at step 70, including by inference from the fact that an identification is made.

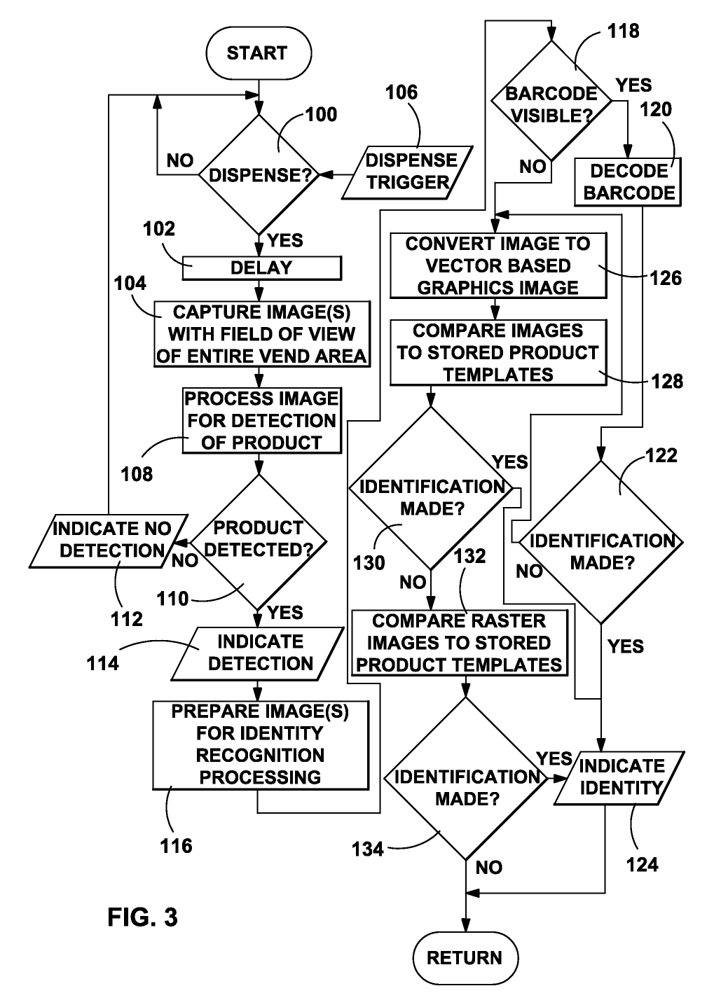

FIG. 3 illustrates steps of an example of a preferred embodiment of the process of FIG. 2. Like the process of FIG. 2, the process beings with detection of items within the vend area and then proceeds with recognition of the products. One or more cameras captures one or more images of at least a portion of the vend area to which a dispensed item is expected to have traveled, as indicated by steps 100, 102, and 104 and dispense trigger input 106. Preferably, one or more visual images, which individually or collectively have a view of the entire vending area, are captured. Similarly, at step 108, the one or more images are processed to detect whether an item is present within the vend area. Alternatively, as indicated by step 110 and output 112, an indication of no detection is given if no product is detected. Such an indication may be made by inference from the failure to communicate detection. Otherwise, detection is indicated at step 114.

At step 116, the vision sensor system prepares images for processing in order to identify object dispensed as being the object requested. In order to reduce processing associated with recognizing the detected product and/or improving recognition, images used to recognize the object are preferably focused on the object or, if a barcode (which would include any sort of graphical element for encoding identification information) is visible and detected, on the barcode. This step therefore includes removing portions of the image(s) acquired in step 104, which are unnecessary for recognition, and/or focusing a camera in the area in which the object is detected and acquiring one or more additional, “close-up” images of the object. In the illustrated embodiment, removing unwanted areas from previously acquired images removes all but the area in which the object is found. Relatively higher resolution images are desirable in a preferred embodiment to ensure recognition success similar to what can be achieved with optically zooming in on the object of interest. If additional images are acquired, the focal length of the camera's optics would be changed and the optics of the camera or a mirror on which the optics are focused would be panned or tilted in order to center a detected object in the field of view. Alternatively, a plurality of cameras, each with a relatively narrower field of view focused on a different (though possibly overlapping) portions of the vend area, could be deployed. Depending on where in the vend area the object is initially detected, one or more relatively narrow field images are acquired from the additional cameras. The relatively narrow field images can be further processed to isolate the portions of the images in which the object or barcode is actually located.

If a barcode is visible at step 118, vision sensor system processing attempts to decode the barcode at step 120. If at step 122 an identification is made, it is indicated at step 124 and the process returns. Otherwise, identification fails, and images are processed further at step 126. Identification may fail if the barcode cannot be decoded, or the decoded information does not match, identifying information stored by the vision detection system.

At step 126, images are, preferably, converted from rasterized or bit-mapped images (which may or may not be compressed) to vector based graphics (VBG) images in order to facilitate and/or improve comparison to predefined product templates at step 128. Conversion simplifies comparison by allowing, for example, differences in luminosity or a color to be ignored in the comparison. Comparison is based on one or more predetermined attributes of the product. The attributes may include one or more of the following: the shape of the product, the size of the product, the color of the product, text or other graphical elements on the product, a UPC bar code on the product, and the like. Spatial information may also be used. Such could include, for example, one or more of the following: if images are acquired with a view of products as they are dispensed and/or fall to a vend area, the point from which the product falls or the products path to the vend area; and the location at which the product falls in the vend area. Preferably, comparison begins with the assumption that the object detected is the product requested. This assumption should, on average, reduce the amount of processing that is necessary for recognition. Other strategies could, however, be employed alone or in combination with these assumptions, such as for example one that creates a list candidate products based on one or more initial observations about the detected object, such as its size. If at step 132 the object as represented in the VBG images correlates to or matches a predefined product template to a degree sufficient to make an identification, identification is indicated at step 124 and the process returns.

If the identification of the detected object using VBG images fails, for example because the degree of probability or certainty of a unique match is not high enough or there is no unique match, further comparisons are made using the original raster images at step 132. Further processing is optional. Various pattern recognition algorithms can be employed to determine a match, depending possibly on the nature of the object characteristics to be used in attempting the recognition. Examples include facial and HLS hue luminosity saturation pattern recognition algorithms. If an identification is made, its identity is indicated at step 124. Otherwise, the process may optionally indicated failed identification before returning.

While the invention has been particularly shown and described by the foregoing detailed description, it will be understood by those skilled in the art that various changes, alterations, modifications, mutations and derivatives in form and detail may be made without departing from the spirit and scope of the invention.

What is claimed is:

1. Apparatus for dispensing items, comprising:
a storage structure for storing a plurality of different types of items to be dispensed;
a dispensing mechanism for selectively causing items in the storage structure to be transported to a dispensed area, from which dispensed items can be retrieved;
at least one sensor for generating visual images, the sensor arranged for viewing at least a portion of the vending area; and
one or more processing entities comprised of one or more circuits executing predefined logic processes, the processing entities in communication with the sensor and dispensing mechanism, the processing entities programmed to perform the following processes: detecting items in the vending area based at least in part on the visual images, and determining whether an item has been vended to the vending area based at least in part on whether an item has been detected.

2. The apparatus for vending of claim 1, wherein the processing entities are programmed for determining the type of item detected in the dispensing area.

3. The apparatus for dispensing of claim 2, wherein the processing entities are further programmed for receiving the identity and the determining whether the item type matches that of a dispensed item.

4. The apparatus for dispensing of claim 3, wherein the processing entities are further programmed for indicating that the identity of the detected items does not match the type of the dispensed item.

5. The apparatus for dispensing of claim 2, wherein the processing entities are programmed for identifying the item type based on one or more predefined attributes.

6. The apparatus for dispensing of claim 5, wherein the one or more predefined attributes are selected from a set comprised of item shape, item size, item bar code, item color, text markings on item, and graphical markings on item.

7. The apparatus for dispensing of claim 5, wherein the processing entities are further programmed for capturing an image from the image sensor after a dispense by the dispensing mechanism is triggered.

8. The apparatus for dispensing of claim 1, wherein the processing entities are further programmed for indicating that more than one item has been dispensed in response to detection of more than one item in the dispensing area.

9. The apparatus for dispensing of claim 8, wherein the processing entities are further programmed for indicating to a user to return one of the multiple items in the dispensing area to a pre-designated area.

10. The apparatus for dispensing of claim 1, wherein the processing entities are further programmed for indicating a failure of an item to be dispensed in response to a failure to detect an item in the dispensing area.

11. The apparatus for dispensing of claim 1, wherein the processing entities are further programmed for indicating detection of multiple items in the dispensing area.

12. The apparatus for dispensing of claim 1, wherein the processing entities are further programmed for converting images received from the sensor to a vector based graphics format.

13. The apparatus for dispensing of claim 12, wherein the processing entities are further programmed for comparing the vector based graphics format to one or more preconfigured templates in order to identify the item.

14. The apparatus for dispensing of claim 1, wherein the processing entities are further programmed for first detecting within the visual image from the sensor a bar code and decoding the bar code.

15. The apparatus for dispensing of claim 14, wherein the processing entities are further programmed for converting the image to a vector based graphics format and comparing the vector based graphics format to one or more predetermined templates if the type of the item cannot be determined from the bar code.

16. Apparatus for dispensing, comprising:
a secure cabinet;
a storage structure within the cabinet for storing a plurality of different types of items to be vended;
a dispensing mechanism for selectively causing items in the storage structure to be transported to a dispensing area in response to a request for the items;
at least one camera for generating visual images, the sensor arranged for viewing at least a portion of the dispensing area; and
one or more processing entities comprised of one or more circuits executing predefined logic processes, the processing entities in communication with the camera and dispensing mechanism, the processing entities programmed to perform the following processes:
detecting items in the dispensing area based at least in part on the visual images;
determining the types of the detected items, determining the types including detecting and decoding a bar code on the item, and, if the bar code cannot be detected or decoded, comparing one or more preselected item attributes to one or more predetermined templates defining one more attributes of each of the plurality of types of items; and
indicating whether the item to be dispensed has been vended to the dispensing area based at least in part on whether an item has been detected and the determination of the item type.

17. The apparatus of claim 16, further comprising a plurality of cameras aimed at different parts of the dispensing area.

18. The apparatus of claim 16, wherein the camera is mounted for adjustably aiming the camera at different parts of the dispensing area.
